(19) United States
(12) Patent Application Publication
(10) Pub. No.: US 2020/0124406 A1
(43) Pub. Date: Apr. 23, 2020

(54) METHOD FOR REFERENCING A PLURALITY OF SENSORS AND ASSOCIATED MEASURING DEVICE

(71) Applicant: Wobben Properties GmbH, Aurich (DE)

(72) Inventor: Waldemar GORSCHENEW, Hannover (DE)

(21) Appl. No.: 16/611,727

(22) PCT Filed: May 8, 2018
(86) PCT No.: PCT/EP2018/061768

§ 371 Date: Nov. 7, 2019

(30) Foreign Application Priority Data
May 8, 2017 (DE) 10 2017 109 854.2

(51) Int. Cl. G01B 11/25; G01N 27/72; G06T 7/521; G01N 21/88; H04N 13/239

(52) U.S. Cl. CPC G01B 11/2513; G01N 27/725; H04N 13/239; G01N 21/8806; G06T 7/521

(57) ABSTRACT

A method for referencing a plurality of sensor units that can be arranged around the measurement object for surveying a three-dimensional surface of a measurement object, and to an associated measuring device for surveying a surface of a measurement object. A more accurate surveying of the surface of the measurement object is provided.

### BACKGROUND

### Technical Field

The invention relates to a method for referencing a plurality of sensors that can be arranged around a measurement object for surveying a three-dimensional surface of a measurement object, and to a method for surveying a measurement object and an associated measuring device.

### Description of the Related Art

The accurate surveying of three-dimensional objects is relevant in many application fields, for example in production, quality assurance, etc. Measuring arrangements comprising a plurality of measuring units are employed to reduce the duration of the survey of large objects. It must be possible for the measuring units to be arranged around the measurement object and thus to survey parts of the object from different perspectives simultaneously. The measuring units can, for example, be surface measuring units that are based on optical principles.

It is a challenge for such measuring arrangements to reference the intrinsic coordinate systems of the individual measuring units to one another to a global coordinate system. Recording reference points with different measuring units, for example by means of a calibration pattern, and transforming the position of the reference points, which is then known in camera coordinates, between the plurality of measuring units is known for this purpose.

Reference points are projected optically on the object to be surveyed in, for example, documents US 2017/0054965 A1 and WO 2004/011876 A1. The use of separate calibration objects is, however, also known from the documents US 2016/0300383 A1 and

Such methods for determining the referencing of the multiple sensors have the disadvantage that the transformation between coordinate systems of a plurality of sensors is based on a reconstruction of the reference points which is, naturally, subject to error. The greater is the difference in the angle of observation between two measuring units, the stronger is the effect of the reconstruction error on the referencing. Specifically in the case of high-precision applications, such a referencing based on the reconstruction is thus not sufficiently accurate.

### BRIEF SUMMARY

Provided is a method for referencing a plurality of sensors and an associated measuring device for surveying a surface of a measurement object in such a way that a more precise survey of the surface of the measurement object is achieved.

Provided is a method for referencing a plurality of sensors that can be arranged around the measurement object for surveying a three-dimensional surface of a measurement object. Each sensor comprises a source of structured illumination and a calibrated optical camera at a fixed distance therefrom. A beam of the source of structured illumination is calibrated with respect to the camera, and a transformation of the image of the structured illumination, which is recorded by the camera, from two-dimensional image points into three-dimensional camera coordinates is determined through the calibration of the sensor.

The method comprises the following steps: i) determining positions of a plurality of reference points in two-dimensional image coordinates of cameras of a first and a second sensor, ii) reconstructing the positions of the plurality of reference points in three-dimensional camera coordinates of the first sensor and of the second sensor, iii) determining a transformation between the three-dimensional camera coordinates of the first sensor and the three-dimensional camera coordinates of the second sensor on the basis of the reconstructed positions of the reference points, iv) reconstructing the position of the image of the structured illumination in the three-dimensional camera coordinates of the first sensor and the second sensor on the basis of the reconstructed reference points, v) determining a triangulated position of the image of the structured illumination in three-dimensional camera coordinates of the first sensor and of the second sensor, and vi) correcting the transformation between the three-dimensional camera coordinates of the first sensor and the three-dimensional camera coordinates of the second sensor on the basis of the triangulated positions of the image of the structured illumination.

Provided is another method comprising the following steps: i) determining positions of a plurality of reference-points in two-dimensional image coordinates of cameras of a first and of a second sensor, ii) determining a coordinate transformation in each case between the camera coordinate system and the coordinate system of the reference points of the first and second sensor, iii) reconstructing the position of the image of the structured illumination in the three-dimensional camera coordinates of the first sensor and the second sensor on the basis of the determined coordinate transformations, iv) determining a triangulated position of the image of the structured illumination in three-dimensional camera coordinates of the first sensor unit and of the second sensor, and v) ascertaining a correction transformation between the reconstructed image and the triangulated image for each sensor, whereby the coordinate transformations determined between the camera coordinate system and the coordinate system of the reference points of the first and the second sensors are corrected, wherein referencing from the first sensor to the second sensor is established on the basis of the corrected transformations.

Expressed otherwise, the correction transformation for correcting the reconstructed position of the image of the structured illumination and/or for correcting a transformation between the three-dimensional camera coordinates of the first sensor and the three-dimensional camera coordinates of the second sensor are accordingly preferably determined on the basis of the triangulated positions of the image of the structured illumination, and the accuracy of the referencing of the sensors with respect to one another is thereby improved.

The same reference points, or, if a defined coordinate system is present in the reference points, only a portion of the reference points, are thus recorded, simultaneously or in sequence, by at least two of the cameras of the sensors. For each of the sensors, a position of the reference points which are, for example, part of a calibration pattern, is determined in 3D space, or is reconstructed in three-dimensional camera coordinates from the two-dimensional image coordinates. Since these are the same reference points, the positions of the reference points reconstructed in this way from the respective three-dimensional camera coordinate systems can be transformed into a common global coordinate system.

Since, however, this transformation is based on reconstructed coordinate transformations or positions of the reference points, it leads to errors that are corrected by means of a triangulation that is additionally carried out. Images of the structured illumination are in particular recorded, preferably in sequence, by each of the sensors, and these are also reconstructed in the same way as the reference points. In addition, the known calibration between the source of structured illumination and the optical camera makes it possible for a triangulated position to be assigned to the image of the structured illumination. Due to the calibrated relationship between the source of illumination and the camera, the triangulated position enables a more accurate position of the image. The transformation between three-dimensional camera coordinates, which initially is based on a reconstruction, is then in an advantageous manner corrected by means of the triangulated positions of the images of both the first sensor as well as of the second sensor, or their deviation from the reconstructed position of the image.

The calibration of the optical cameras comprises a calibration of intrinsic and extrinsic camera parameters. The calibration is, for example, carried out according to Zhang, according to Tsai, or according to other known calibration methods.

The calibration of the source of structured illumination with reference to the optical camera takes place in an implementation in which a plurality of images of the structured illumination are recorded, are then reconstructed, and the beam of the source of structured illumination is adjusted, for example by means of a singular value decomposition. Other methods for calibration of the source of structured illumination with reference to the optical camera are, of course, also possible.

The method is based on sensors each of which comprises a source of structured illumination and an optical camera calibrated thereto. In other forms of embodiment, the sources of structured illumination can also be provided independently of the calibrated optical camera.

In one form of embodiment, the sensors comprise laser line sources as the source of structured illumination, and the image of the structured illumination is a laser line. In this form of embodiment the beam of the structured illumination is a laser plane that is calibrated with reference to the camera coordinates. An image of the laser line in two-dimensional image points thus corresponds to an intersection point of the laser plane with the surface of the measurement object which can easily be determined through a triangulation with reference to the beam path. Although in this form of embodiment, laser lines and laser intersection sensors are proposed as examples for sources of structured illumination, any other desired sources of structured illumination can also be used in other forms of embodiment.

The laser line is preferably segmented, for example by a bandpass filter, during the process of laser plane calibration. For this purpose, a high power of the laser line source can preferably, together with a reduction of the exposure time of the optical camera, lead to the laser line being almost exclusively visible in the picture of the representative image. Since preferably laser light of a single wavelength is used, for example red laser light, interfering wavelengths can, moreover, be filtered out by a bandpass filter in front of the camera. Through the use of a monochromatic light source, furthermore, the occurrence of chromatic aberrations or other imaging faults can be avoided.

In one form of embodiment, the referencing relates to more than two sensors, wherein all the sensors are referenced to one another. It is thus advantageously possible to combine the structured illuminations that are recorded by each of the sensors into a global coordinate system. A total surface of the measurement object can thus be determined.

In one form of embodiment, all of the sensors are referenced directly or indirectly to the first sensor. The error of a transformation between the camera coordinate systems of two sensors rises with the difference in the position and the orientation of the respective cameras. In the case of indirect referencing, one sensor is indirectly referenced to the first sensor by way of a third sensor. As a result, two transformations, namely between the second and the third as well as between the third and the first sensor are combined together. The second and third sensors are naturally only exemplary for all the sensors; the procedure is also applicable to all other possible sensors. Depending on the arrangement of the sensors, the type of referencing that enables the smallest error can thus be chosen.

In one form of embodiment the sensors are arranged in one plane. This yields advantages in particular when profile sections of the measurement object are of interest. In the case, for example, in which the sensors comprise laser line sources, surface profile sections of the measurement object can be recorded in this way.

In one form of embodiment, the sensors comprise laser line sources as the source of structured illumination and the laser planes of the sensors are essentially coincident.

For example, when applied to rotor blades for wind power installations as measurement objects, profile surface sections recorded in this way that lie in the laser plane of the sensors are suitable for CFD simulation with high accuracy. Different surface profile sections of this sort can then be combined into a total surface profile of the measurement object, in this case the rotor blade.

In one form of embodiment the relative position of the sensors to one another is changed, while the referencing of the sensors is adjusted according to the relative position of the sensors.

This form of embodiment is also particularly suitable for measurement objects in which scale effects of the extension occur. The rotor blades of wind power installations are an example of such measurement objects. These have very large profile diameters and circumferences in the region close to the hub, which generally reduce towards the blade tip. In order to achieve the same measurement accuracy, which is to say resolution, for each surface element of the surface, over all the regions of the rotor blade, it is advantageous to change the relative position of the sensors with respect to one another and to the measurement object. In particular, the sensors can thus be brought closer to the measurement object or moved further away from the measurement object in order to ensure the necessary resolution. The referencing is adjusted in an advantageous manner to the relative position, so that in spite of changes in the relative position of the sensors, excerpts of the surface of the measurement object detected by means of the structured illumination can be combined to form a total surface of the measurement object.

In one form of embodiment the plurality of reference points are coplanar. This can, for example, take place by means of a calibration pattern, for example in the form of a checkerboard pattern. In other forms of embodiment, calibration patterns that do not lie in one plane, but which for example extend in three dimensions, are also possible.

In one form of embodiment, the step of reconstructing the position of the plurality of reference points in three-dimensional camera coordinates comprises a perspective-n-point method.

The perspective-n-point method is particularly suitable for estimating a pose, that is to say the determination of a plane, of coplanar points. The perspective-n-point method is, however, only an example of reconstructing the position of the plurality of reference points; other methods are, for example, based on epipolar geometry and/or include further methods known to the expert.

In one form of embodiment, the step of correcting the transformation between the three-dimensional camera coordinates of the first sensor and the three-dimensional camera coordinates of the second sensor on the basis of the triangulated positions of the images of the structured illumination comprises a rigid body transformation.

A rigid body transformation refers to a Euclidean transformation without reflections from a three-dimensional space into a three-dimensional space, or from a two-dimensional space into a two-dimensional space. The rigid body transformation consists only of rotation and translation, wherein no scaling, shear etc., occurs. In contrast to this, in the case of a transformation using, for example, perspective-n-point while using a direct linear transformation, a projective transformation which is not rigid occurs. This is, for example, a transformation from two-dimensional to three-dimensional coordinates which is determined by a projection matrix composed of rotation components, translation components as well as additional scaling and/or shear components.

Provided is a method for surveying a measurement object wherein the measurement object is surveyed with a plurality of sensors referenced to one another using a method in accordance with one of the forms of embodiment according to the invention, wherein the sensors are configured for capturing a surface excerpt of the measurement object, while the sensors are arranged for this purpose in particular in one measurement plane.

Since the method for surveying uses the sensors referenced according to a form of embodiment according to the invention, a particularly accurate survey of the measurement object is made possible. This is made possible in particular in that the surface excerpts of the measurement object that are captured by the respective sensors are combined into a larger segment of the surface, wherein the combination takes place by means of the referencing. A particularly simple calculation is in particular enabled since the sensors are additionally arranged for this purpose in one measurement plane. In the case, in particular, in which laser light section sensors are involved, surface profile excerpts can be achieved which are preferably combined into a total surface profile section, wherein each of the sensors supplies a contribution to the surface profile section.

The measurement object is, preferably, a rotor blade of a wind power installation; the method is, however, particularly suitable for measurement objects that are large or complex in shape, which require the use of a plurality of sensors or views.

In one form of embodiment, the sensors are moved relative to the measurement object, and a plurality of surface excerpts are combined into one surface of the measurement object.

Since the sensors are moved relative to the measurement object, the entire measurement object can advantageously be surveyed. The relative movement of all the sensors with respect to a fixed point can, in particular, be determined, and this relative movement used for combining the surface excerpts into one surface. In one preferred embodiment, surface profile sections, obtained for example through laser section sensors, are combined to a total surface profile of the measurement object. Preferably the resolution of this combined surface is sufficiently good that CFD simulations can, for example, be carried out.

In one form of embodiment the relative distances of the sensors to one another are changed at different positions of the measurement object, while the referencing of the sensors is adapted to the relative distances of the sensors.

Through changing the relative distances of the sensors, it becomes possible to avoid the resolution of the survey of the surface of the measurement object being impaired by different profile diameters of the measurement object at different places. A consistent resolution of the surface can in particular be ensured over the entire measurement object.

In one form of embodiment, the relative distances of the sensors are changed in steps. The referencing of the sensors is adapted to the relative distances of the sensors after the change takes place in steps; a previously ascertained referencing, for example for the currently set step of the relative distance, can be employed. Continuous changes of the relative positions of the sensors are, alternatively, also possible, wherein the relative distances are preferably taken into account for the referencing through an interpolation. Alternatively the referencing can of course be carried out in each case after the change of the relative distance.

In one form of embodiment, the surface excerpts are surface profile excerpts that are combined to a surface profile section, wherein a plurality of surface profile sections are combined into one surface profile.

Provided is a measuring device for surveying a surface of a measurement object, wherein the measuring device comprises a plurality of sensors arranged in a measuring plane and a position monitoring unit, wherein the sensors are configured to be referenced in the measurement plane by means of a method according to the forms of embodiment according to the invention, wherein the position monitoring unit is configured to determine the position of the measurement plane with reference to a stationary reference. The measurement object is preferably a rotor blade of a wind power installation.

The measuring device achieves all the advantages that are achieved through the method for referencing the sensors or the method for surveying the measurement object. The measuring device is in particular suitable for implementing all of the preferred embodiments of the described method. Although a rotor blade of a wind power installation is mentioned as a preferred measurement object, the application of the measuring device is not restricted thereto, and all further measurement objects whose surfaces are surveyed can be surveyed accurately by the measuring.

In one form of embodiment, the measuring device further comprises a movement unit for moving the measurement plane relative to the measurement object.

Since the measuring device can be moved relative to the measurement object, large measurement objects can also be fully surveyed by means of the measuring device. The movement unit preferably enables a linear movement along the measurement object, which is particularly suitable for longer measurement objects, precisely such as rotor blades of wind power installations, or also wings and similar objects.

### BRIEF DESCRIPTION OF THE SEVERAL VIEWS OF THE DRAWINGS

Exemplary embodiments, along with the advantages achieved through the solutions according to the invention, are described below with reference to the appended figures.

FIG. 1 shows schematically an exemplary embodiment of a measuring device,

FIG. 2 shows schematically and in an exemplary manner the principle of function of a laser section sensor,

FIGS. 3a and 3b show schematically and in an exemplary manner a position determination unit of the measuring system,

FIG. 4 shows in an exemplary manner a flow diagram of a method for referencing a plurality of sensors, FIG. 5 shows schematically and in an exemplary manner the principle of the camera calibration,

FIG. 6 shows schematically and in an exemplary manner the referencing of a plurality of sensors, and

FIG. 7 shows schematically and in an exemplary manner the correction of the referencing from FIG. 6.

### DETAILED DESCRIPTION

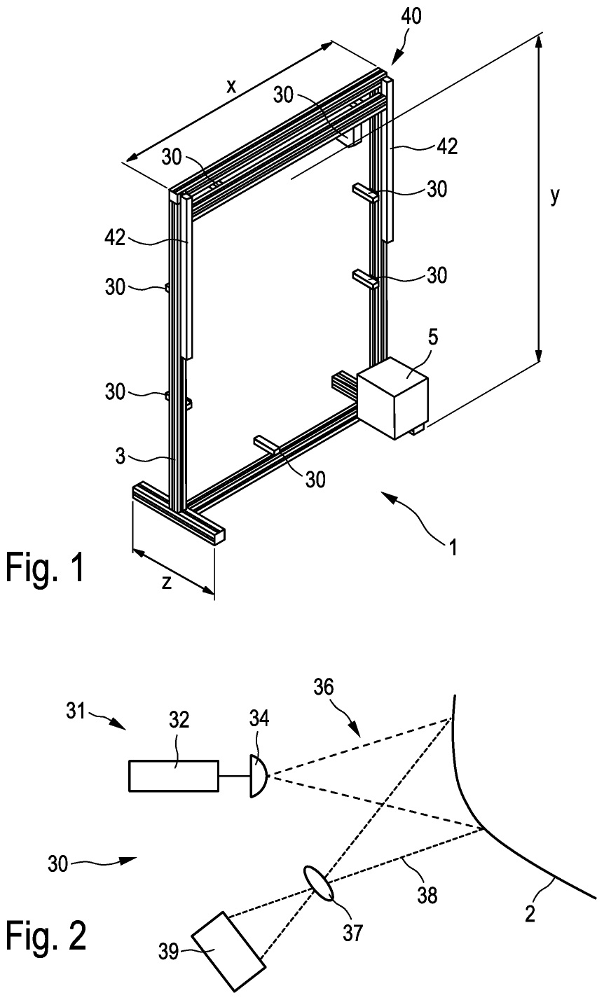

FIG. 1 shows schematically an exemplary embodiment of a measuring device 1. The measuring device 1 comprises a carrier unit 3 that is designed in the form of a frame, as well as a movement unit 5 by means of which the frame 3 can be moved. In this example, the frame extends over a width x and a height y, and can be moved by means of the movement unit 5 in a longitudinal direction z which is perpendicular both to the width x and to the height y. The width x and the height y define in this exemplary embodiment the measurement plane of the measuring device 1. The selection of the axes is exemplary, and can be different in other exemplary embodiments. Although in this example the width x, height y and length z are all perpendicular to one another, this can also be different in other exemplary embodiments.

In this example, the movement unit 5 is an electric motor which moves the measuring device 1 along the longitudinal direction z over a rail (not illustrated) on the ground on which the frame 3 is placed, for example by means of wheels.

In this example, seven sensors 30 are provided inside the frame 3. The sensors 30 are each aimed from the frame 3 inwards in the measurement plane onto the region in which a measurement object is to be introduced. In this example, two sensors 30, arranged namely at the upper end of the frame 3, are fastened to the frame 3 by means of an advance unit 40. The advance unit 40 makes it possible for the sensor 30, which is fastened to the frame 3 by the advance unit 40, to be moved in the measurement plane. In this example, the advance unit 40 comprises two parallel, linear advance elements 42 that are arranged at vertical partial segments of the frame 3 and which support a horizontal beam movably in the vertical direction y between the two linear advance elements 42. In other exemplary embodiments, only one or more than two of the sensors 30 are fastened to the frame 3 by means of the advance unit 40, preferably in particular all the sensors 30. Each of the sensors 30 can have a dedicated advance unit 40, or a plurality of the sensors 30 can be advanced with a common advance unit 40. The advance makes it possible for the distances of the sensors 30 from the surface of the measurement object to be adjusted in such a way that a resolution of the surveying of the surface is always sufficiently high. This is particularly of great relevance in the case of measurement objects that have large differences in their cross-section.

Although the sensors 30 are arranged in this exemplary embodiment in a frame 3 of the measuring device 1, all other arrangements in which a plurality of sensors 30 can be arranged around the measurement object for surveying a measurement object are available to the method for referencing, since this is not restricted by the mechanical arrangement of the sensors 30.

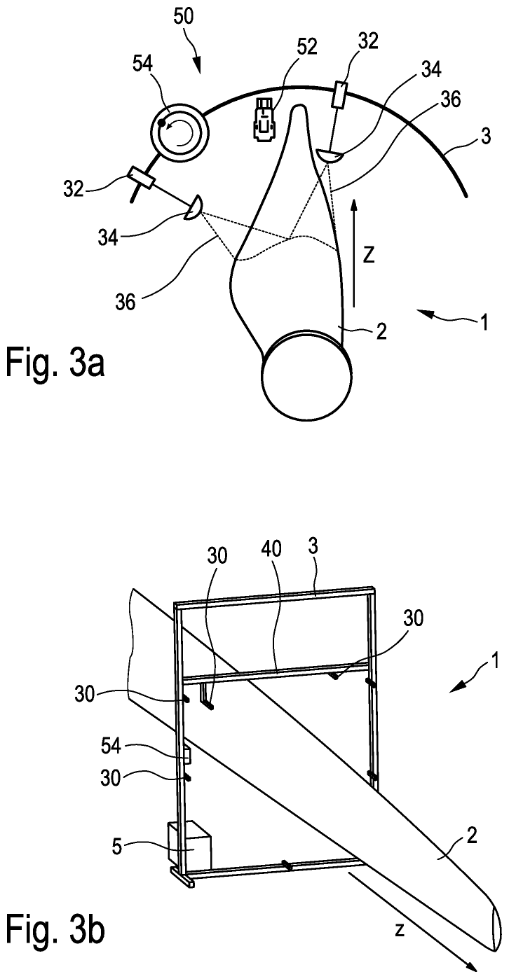

FIG. 2 shows schematically the principle of function of a laser section sensor as an example of a sensor unit 30. In this example, the sensor 30 is a laser light section sensor that comprises a laser light source 32, a cylindrical lens 34, a lens 37 and a detector, for example a camera 39. The combination of laser light source 32 and cylindrical lens 34 is an example here of a source 31 of structured illumination which in other examples can also generate different and more complex structured illuminations as laser lines.

The punctiform light transmitted by way of example from the laser light source 32 is split by means of the cylindrical lens 34 into a line. The line emerges from the sensor 30 and onto a surface of the measurement object 2. The incoming laser light 36 is reflected at the surface 2, and enters the camera 39 via the lens 37 as the reflected line 38. The height profile of the surface 2 can be calculated from the offset of the laser line arriving at the camera 39. Laser light section sensors are based on the known principle of laser triangulation, wherein the punctiform light source is broadened into a two-dimensional line. The laser light sensor is only one example of sensors 30 suitable for surveying surfaces which can be employed in the measuring system 1 and in the method described herein.

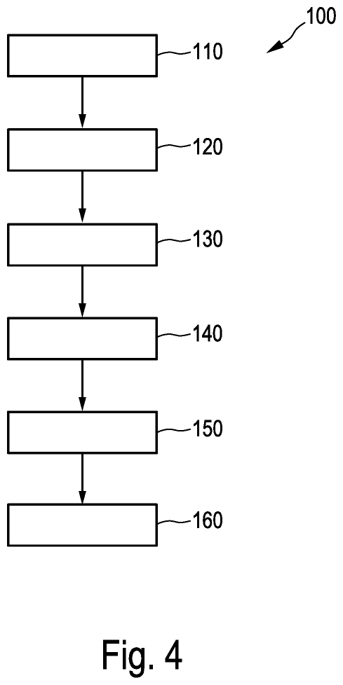

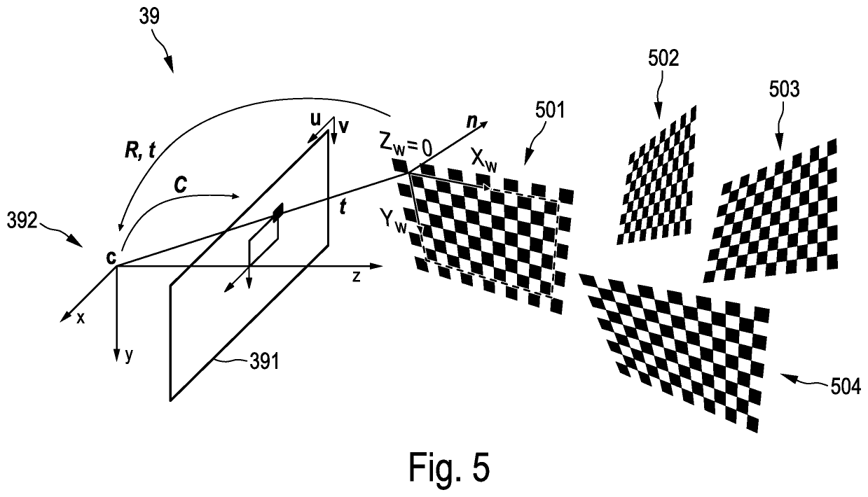

FIG. 3a shows schematically and in an exemplary manner a position determination unit 50 that is employed in a measuring device 1. In FIG. 3a the sensors 30 are illustrated schematically by the laser light source 32 and the cylindrical lens 34, which are arranged on a schematic frame 3 sketched in the form of a semicircle. Further elements of the sensors 30 are omitted for the sake of clearer illustration. FIG. 4a further shows a rotor blade as an example of a measurement object 2 which is moved in the longitudinal direction z along the frame 3.

The position determination unit 50 comprises a position laser 52 and a retroreflector 54. The position laser 52 is stationary, and arranged independently of the frame 3. It does not move when the frame 3 is moved by means of the movement unit 5. The position laser 52 measures the distance from the retroreflector 54, which moves with the frame 3. The retroreflector 54 reflects the radiation arriving from the position laser 52 back to the position laser 52 largely independently of the alignment of the retroreflector 54 in respect of the position laser 52. The retroreflector 54 is preferably guided continuously on a circular or elliptical track. The circular or elliptical track of the retroreflector 54 can develop with reference to an application surface that is fastened to the frame 3 or with reference to the entire frame 3. Since the frame 3 moves in the longitudinal direction Z and the retroreflector 54 simultaneously is located on a circular or elliptical track, a helical type of trajectory results, from which the position and orientation of the frame 3 of the measuring device 1 can be determined at any point in time.

FIG. 3b shows schematically and in an exemplary manner the measuring device 1 shown in FIG. 1, together with the measurement object 2 which in this example is the blade tip of a rotor blade. The frame 3 is moved along the rotor blade 2, while the sensors 30 capture profile sections of the measurement object 2 continuously or at specified distances in the longitudinal direction of the rotor blade. In the example shown in FIG. 3b a stationary retroreflector 54 is shown instead of the rotating retroreflector 54. In this example again, the retroreflector 54 can be employed in order to determine the distance from the position laser 52 (not shown in FIG. 3b).

The measuring device 1 is suitable for capturing a three-dimensional surface geometry of a measurement object 2 automatically. In particular in the case of large dimensions of the measurement object 2 and for the high measurement resolution necessary for a meaningful determination of the surface geometry of the measurement object 2, the measurement is accordingly not made from a stationary location of the measuring device 1, but from different positions in that the frame 3 is moved by means of the movement unit 5 along the measurement object 2, and the sensors 30 thus perform a movement relative to the measurement object 2 during the measurement process. A carrier unit, for example in the form of a frame 3 with a plurality of sensors 30 which are, for example, optical triangulation sensors such as laser light section sensors, is for example moved along a rail system at the measurement object 2 and tracked precisely with the aid of a position determination unit 50. The position determination unit 50 is, for example, a position laser 52 that determines the distance to a retroreflector 54 that is attached to the frame 3. A sequence of complete profile sections of the measurement object 2 is thus created. Single measurements of profile sections can be merged to form a three-dimensional total model with high resolution. Autonomous or preprogrammed industrial trucks can here also be employed as the movement unit 5 for moving a carrier unit 3. The portal can also be fastened in a manner permitting free manipulation to an industrial robot in order to be able to describe arbitrary spatial curves as the path of travel along a measurement object.

The advance component 40, which is configured to adjust the distance of the sensors 30 from the measurement object 2, ensures that the measurement resolution of the surface of the measurement object 2 is sufficiently large regardless of the diameter of the measurement object 2 at the position at which the current profile section is being measured. Through a comparison with, for example, a CAD model, deviations of the three-dimensional total model can be determined.

A significant sag due to gravity, which occurs in particular in the case of long measurement objects 2 such as the rotor blades of a wind power installation, can be simulated, and taken into account for the evaluation. In the case of rotor blades of a wind power installation for example, the measurement data recorded by the measurement system 1 form the basis for a flow simulation for performance assessment or for acoustic evaluation of the rotor blade.

With the measuring device 1 it becomes possible for the total measuring time for one rotor blade to be not longer than 30 minutes. In this time a profile section can be taken every 2 millimeters in the longitudinal direction of the measurement object 7 with the measuring device 1. With the measuring system, the local measurement error at the front and rear edges of the profile can be in the range between 0.05 to 0.17 mm on the pressure side and between 0.07 to 0.41 mm on the suction side. A guarantee for the performance figures or the acoustic figures of the rotor blade can be maintained within these tolerance ranges.

The description of the figures for FIGS. 4 to 7 for achieving the necessary resolution is described below with reference to FIGS. 4 to 7 the method for referencing a plurality of sensors.

FIG. 4 shows schematically a flow diagram of a method 100 for referencing a plurality of sensors, for example the sensors 30. The sensor has, quite generally, a source of structured illumination and a calibrated optical camera at a fixed distance therefrom. The source of structured illumination can, for example, be a laser beam which is widened into a line by means of a cylindrical lens, as is shown in the examples in FIGS. 1 to 3. Other light patterns with known structure by means of which the objects are illuminated and which enable 3D height information for reconstruction of the surface of the object are, however, also suitable. The camera calibration includes the calibration of intrinsic and extrinsic camera parameters that are ascertained in accordance with known methods.

The source of structured illumination transmits a beam which reduces to a plane in the case of a laser line. This beam is also calibrated with reference to the camera, which permits a triangulation of the object points at which the incoming light is reflected and which is then received in the optical camera from the ray path of the structured illumination. After the sensor has then been calibrated, the association between two-dimensional image points of the light that was transmitted from the source of structured illumination and was reflected at the measurement object can be assigned to precisely one image point in three-dimensional coordinates that corresponds to the surface of the measurement object. Expressed otherwise, the calibration of the sensor unit enables a precise assignment between the image of the structured illumination that the camera records in two-dimensional image points, and the reflections at the object surface in three-dimensional camera coordinates that underlie this image.

A problem underlying the invention then occurs when a plurality of sensors that are to be arranged around the measurement object for surveying a three-dimensional surface must be referenced to one another. In particular in the case of complex geometries of the measurement objects, highly curved objects or objects with undercuts or inclusions for example, the use of a plurality of sensors is frequently the only solution for achieving a measurement of the surface of the measurement object within an acceptable time.

The method 100 for referencing a plurality of sensors comprises initially, in step 110, a determination of the positions of a plurality of reference points in two-dimensional image coordinates by the cameras of a first and second sensors 30. The plurality of reference points can, for example, be arranged on a simple two-dimensional reference object such as a two-dimensional checkerboard pattern. No further requirement is placed on reference points; in other examples, reference points that are not coplanar (for example not in a two-dimensional checkerboard pattern) are also conceivable as reference points. The positions of the plurality of reference points are specified in the same positions of the reference points, meaning for example of the reference object, of at least the first and second sensors that are to be referenced to one another. In the simplest case, the exemplary checkerboard pattern is accordingly recorded in the same position by the first and second camera. The recognition of the reference points in the two-dimensional image coordinates takes place through evaluation of the recorded images.

In step 120 the position of the plurality of reference points in three-dimensional camera coordinates of the first sensor and of the second sensor is reconstructed. Through the reconstruction of the positions of the plurality of reference points, the position of a plane of the reference object in which the reference points lie can, for example, be determined. Expressed otherwise, for each coordinate transformation between the camera coordinate system and the coordinate system of the reference points the for each of the sensors.

The principle of the camera calibration is shown schematically with reference to FIG. 5, which is also employed for reconstruction of the positions of the reference points. For the exemplary planar calibration of the camera 39, a plurality of recordings of the two-dimensional checkerboard pattern is captured in pose 501, 502, 503 and 504. A rotation matrix R and a translation vector t should then be determined for each of the poses, which transforms an image of the two-dimensional checkerboard pattern on a sensor plane 391 of the camera 39 in the two-dimensional image points u and v into three-dimensional camera coordinates x, y and z. A lens 392 of the camera is drawn behind the sensor plane 391, since this corresponds optically to the same beam path as if the sensor plane were drawn mirrored and behind the lens 392, but this is more easily illustrated. A matrix C describes the relationship between the sensor plane 391 and the camera coordinates x, y and z with respect to the coordinate origin c arranged in the lens 392. It is now easily possible to describe the points lying in the plane with the coordinates x_{w}, y_{w} and z_{w}=0, and to determine the transformation by means of a normal vector n which extends perpendicularly to the checkerboard pattern. This calibration according to Zhang is to a large extent known, while other calibration methods, in particular also making use of other reference objects, are also conceivable.

For the step 120 then, after the camera calibration has been done successfully, only the reference points in a single pose are necessary. The known camera calibration namely makes it possible for the plurality of reference points from the two-dimensional image data to be reconstructed in three-dimensional camera coordinates. Positions in three-dimensional camera coordinates of the same reference points are thus present for a plurality of sensors.

In step 130, on the basis of the reconstructed positions, a transformation is then determined between the three-dimensional camera coordinates of the first sensor and the three-dimensional camera coordinates of the second sensor.

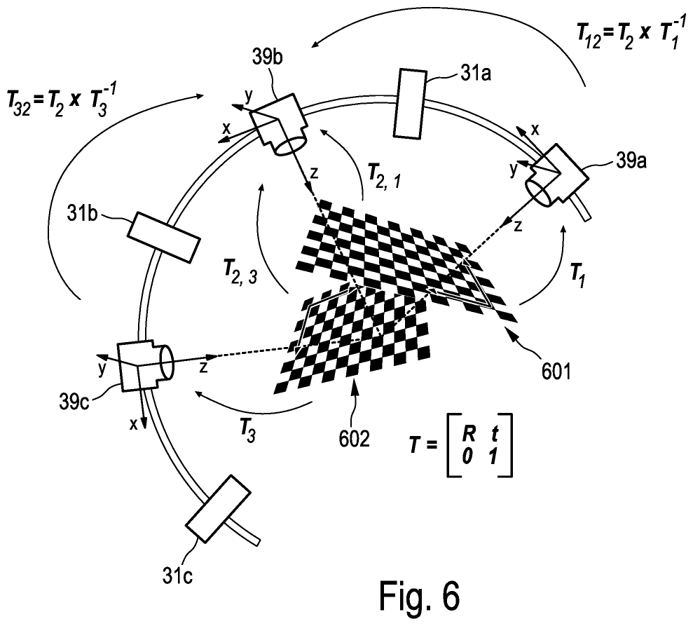

The referencing of a plurality of sensors is described schematically with reference to FIG. 6. A first camera 39a and a second camera 39b capture the same position of the exemplary two-dimensional checkerboard pattern 601 as a reference object that has reference points. A third camera 39c which, together with the second camera 39b, captures a second view of the checkerboard pattern 602, is further shown. This makes it possible for the camera 39a to be referenced with respect to the camera 39b and for the camera 39c also to be referenced with respect to camera 39b. A direct referencing of the camera 39c with respect to the camera 39a is not possible, since the camera 39c does not have a suitable view of the reference surface 601. For other arrangements of the cameras 39a, 39b and 39c, or for other poses of the reference points or of the reference object, it is also possible for all the cameras to be referenced directly with respect to one another. Fundamentally, however, an indirect referencing is also possible, in which two sensors or cameras are referenced via an intermediate unit, in this case the camera 39b.

The translation matrix T1 indicates a matrix, as stated, that is composed of the rotation R and the translation vector t. The extrinsic transformation T accordingly enables a transformation of global coordinates to camera coordinates. The Perspective-n-Point algorithm or, preferably, a non-iterative Perspective-n-Point approach, which is known as the efficient Perspective-n-Point algorithm (ePnP), is used to determine this transformation. An extrinsic transformation, for example T₁ for camera 39a and T₂ for camera 39b, can accordingly be obtained for a plurality of sensors in the same pose, for example 601, of the exemplary two-dimensional checkerboard pattern. The registration between the two sensors can then be obtained in the form T₁₂=T₂ T₁⁻¹. It has, however, been found that sufficient accuracy is not achieved with this kind of sensor referencing. The referencing must accordingly be improved further.

In a step 140 the position of the image of the structured illumination in the three-dimensional camera coordinates of the first sensor and of the second sensor is reconstructed for this purpose. The structured illumination of the sources 31a, 31b and/or 31c are recorded for this purpose in temporal sequence by the respective cameras 39a, 39b and 39c. The position of the image of the structured illumination reconstructed in step 140 is subject to the same estimation errors as the reconstruction of the reference points determined in step 120.

In step 150, in addition to the position reconstructed in step 140, a triangulated position of the image based on the calibrated beam of the structured illumination is determined. In contrast to the reconstructed position, the triangulated position is not subject to the error of pose estimation.

Finally, in step 160, the transformation between the three-dimensional camera coordinates of the first sensor and the three-dimensional camera coordinates of the second sensor are corrected on the basis of the triangulated position determined in step 150.

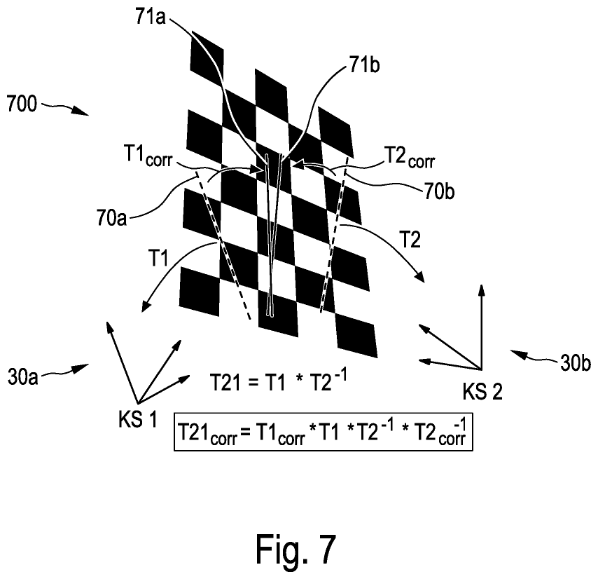

The correction of the referencing transformation is described schematically and in an exemplary manner with reference to FIG. 7. In order to correct the originally reconstructed poses, a rigid body transformation is carried out between reconstructed and triangulated data. For the first sensor 30a, the position of the image of the structured illumination is shown both as a reconstructed line 70a and as a triangulated line 71a. In this example, the images of the structured illumination are laser line sections which can, however, also adopt different shapes in other examples. A correction transformation T1_{corr}, is determined between the reconstructed image 70a the triangulated image 71a, which is assumed to be the correct position. The same applies to the second sensor 30b, for which a reconstructed image 70b and a triangulated image 71b are shown, between which a correction transformation T2_{corr} is determined. Preferably the reference object is recorded for this purpose in a further pose, and estimations of the pose, as well as reconstructions and triangulations, are then repeated. In the exemplary case of laser section sensors, the triangulated lines in all the poses of the reference object are coplanar, whereas the estimated reconstruction data are not necessarily so, since there are errors in the estimation of the pose. This also of course applies correspondingly, in a general sense, to all forms of structured illumination. Taking these correction transformations T1_{corr} and T2_{corr} into account, a corrected referencing of the second sensor 30b to the first sensor 30a, or vice versa, is then obtained via the transformation T21_{corr}. Corresponding corrections can be determined in arrangements with more than two sensors, as well as for all further sensors.

Misalignments, or desired repositionings and tilting of sensors are recognized with the sensor registration, and registered appropriately in the total model. The proposed method thus combines an estimation of the pose that is, for example, performed with the ePnP algorithm, and an approach for determining a rigid body transformation for the trustworthy data that is given through triangulated data for each sensor. The flexibility of the method is based on the applicability concerning other algorithms for estimating the pose, such as for example polar geometry, as well as the reference objects used which can be two-dimensional or three-dimensional and only have to define a plurality of reference points and thus can also be simple geometric shapes. The poses can, for example, also be estimated through the direct linear transformation (DLT), and through the reference objects used for the camera calibration that was previously used. It is only necessary to ensure that enough information of the reference object is present in the overlapping region of the two adjacent camera systems, and that the beams of the structured illumination intersect the reference object.

Although the illustrated exemplary embodiments show a rotor blade 2 of a wind power installation as an example of a measurement object, the effects and advantages achieved through the invention are also applicable to other measurement objects, in particular long measurement objects of variable cross-section.

1. A method for referencing first and second sensors arranged around an object to be measured for surveying a three-dimensional surface of the object,
wherein each sensor of the first and second sensors comprises a source of structured illumination and optical camera at a fixed distance the source of structured illumination,
wherein in each sensor a beam of the source of structured illumination is calibrated with respect to the camera, and a transformation of the image of the structured illumination, which is recorded by the camera, from two-dimensional image points into three-dimensional camera coordinates is determined through the calibration of the sensor,
wherein the method comprises:
determining positions of a plurality of reference points in two-dimensional image coordinates of cameras of the first and a second sensor,
reconstructing the positions of the plurality of reference points in three-dimensional camera coordinates of the first sensor and of the second sensor,
determining a transformation between the three-dimensional camera coordinates of the first sensor and the three-dimensional camera coordinates of the second sensor based on the reconstructed positions of the reference points,
reconstructing the position of the image of the structured illumination in the three-dimensional camera coordinates of the first sensor and the second sensor based on the reconstructed reference points,
determining a triangulated position of the image of the structured illumination in three-dimensional camera coordinates of the first sensor and of the second sensor, and
correcting the transformation between the three-dimensional camera coordinates of the first sensor and the three-dimensional camera coordinates of the second sensor based on the triangulated positions of the image of the structured illumination.

2. A method for referencing a plurality of sensors arranged around an object to be measured for surveying a three-dimensional surface of the object,
wherein each sensor of the plurality of sensors comprises a source of structured illumination and a calibrated optical camera at a fixed distance from the source of the structured illumination,
wherein in each sensor a beam of the source of structured illumination is calibrated with respect to the camera, and a transformation of the image of the structured illumination is recorded by the camera and is determined from two-dimensional image points into three-dimensional camera coordinates through the calibration of the sensor,
wherein the method comprises:
determining positions of a plurality of reference points in two-dimensional image coordinates of cameras of a first sensor and a second sensor,
determining in each case of a coordinate transformation between the camera coordinate system and the coordinate system of the reference points of the first sensor and the second sensor,
reconstructing the position of the image of the structured illumination in the three-dimensional camera coordinates of the first sensor and the second sensor based on the determined coordinate transformations,
determining a triangulated position of the image of the structured illumination in three-dimensional camera coordinates of the first sensor and of the second sensor, and
ascertaining a correction transformation between the reconstructed image and the triangulated image for each of the first and second sensors, wherein the coordinate transformations determined between the camera coordinate system and the coordinate system of the reference points of the first and the second sensors are corrected, wherein referencing from the first sensor to the second sensor is established based on the corrected transformations.

3. The method as claimed in claim 1, wherein the reference points are points of a reference object in two or more poses, wherein the reconstructed and triangulated position of the image of the structured illumination is determined for each of the two or more poses.

4. The method as claimed in claim 1, wherein the first and second sensors comprise laser line sources as the source of structured illumination and the image of the structured illumination is a laser line.

5. The method as claimed in claim 1, wherein the first and second sensors are a plurality of sensors.

6. The method as claimed in claim 5, wherein all of the plurality sensors are referenced directly or indirectly to the first sensor.

7. The method as claimed in claim 5, wherein all of the plurality of sensors are arranged in a single plane.

8. The method as claimed in claim 7, wherein each of the sensors comprise one or more a laser line source as the source of structured illumination and the laser planes of the sensors are essentially coincident.

9. The method as claimed in claim 1, further comprising changing a relative position of the first and second sensors, while the referencing of the sensor is adjusted according to the relative position of the first and second sensors.

10. The method as claimed in claim 1, wherein the plurality of reference points are coplanar.

11. The method as claimed in claim 1, wherein the reconstructing the positions of the plurality of reference points in three-dimensional camera coordinates comprises a Perspective-n-Point method.

12. The method as claimed in claim 1, wherein the correcting the transformation between the three-dimensional camera coordinates of the first sensor and the three-dimensional camera coordinates of the second sensor based on the triangulated positions of the images of the structured illumination comprises a rigid body transformation.

13. A method comprising:
surveying an object for use with a wind power installation, wherein the object is surveyed with a plurality of sensors referenced to one another using the method in accordance with claim 1, wherein the plurality of sensors are configured for capturing a surface excerpt of the object.

14. The method as claimed in claim 13, wherein the plurality of sensors are moved relative to the object, and a plurality of surface excerpts combine together to form a total surface of the object.

15. The method as claimed in claim 13, wherein the relative distances of the plurality of sensors to one another are changed at different positions of the object, while the referencing of the sensors is adapted to the relative distances of the plurality of sensors.

16. The method as claimed in claim 15, wherein the relative distances of the plurality of sensors are changed.

17. The method as claimed in claim 13, wherein the surface excerpts are surface profile excerpts that are combined to form a surface profile section, wherein a plurality of surface profile sections are combined into one surface profile of the object.

18. A measuring device for surveying a surface of an object of a wind power installation, wherein the measuring device comprises:
a plurality of sensors arranged in a measuring plane; and
a position determination unit,
wherein the sensors are configured to be referenced in the measurement plane by the method as claimed in claim 1,
wherein the position determination unit is configured to determine the position of the measurement plane with reference to a stationary reference.

19. The measuring device as claimed in claim 18, further comprising a movement unit for moving the measurement plane relative to the object being measured.

20. The measuring device as claimed in claim 18, wherein measuring device is for surveying a surface of a rotor blade of the wind power installation.
